(19) United States
(12) Patent Application Publication
(10) Pub. No.: US 2026/0264838 A1
(43) Pub. Date: Sep. 10, 2026

(54) ROTARY ACTUATOR-LOCKABLE HINGE DEVICE

(71) Applicant: The Boeing Company, Arlington, VA (US)

(72) Inventor: Tyler Alan STARK, Seattle, WA (US)

(73) Assignee: The Boeing Company, Arlington, VA (US)

(21) Appl. No.: 19/070,284

(22) Filed: Mar. 4, 2025

(51) Int. Cl. B64C 3/54; F16C 11/04

(52) U.S. Cl. CPC B64C 3/56; B64C 3/546; B64C 9/02; F16C 11/04

(57) ABSTRACT

A hinge device having a first member configured to attached to a first body, a second member configured to attach to a second body and to rotate relative to the first member to move the first body relative to the second body, and a selecting portion configured to selectively change modes of the hinge device between a first mode in which the first member and the second member are prevented from rotating relative to each other, a second mode in which the second member can rotate in a first direction relative to the first member and is prevented from rotating in a second direction opposite the first direction, and a third mode in which the second member can rotate in both the first direction and the second direction relative to the first member.

### FIELD

This disclosure relates to a rotary actuator-hinge device, and more particularly to a rotary actuator-hinge device configured to transmit load with high efficiency, disconnect input load from output smoothly even when highly loaded and/or provide selectable locking and direction control.

### BACKGROUND

Aileron, folding wing tips and the like are conventionally operated with hydraulic actuation using a combination of valves to control flow or electro mechanical and/or gearbox based actuation via clutches which are complex, heavy, and large which may not be suitable for a thin wing.

It may be desirable to provide a rotary actuator-hinge device configured to transmit load with high efficiency, disconnect input load from output smoothly even when highly loaded and provide selectable locking and direction control in a more compact and simplified configuration than conventions clutch mechanism.

### SUMMARY

According to various implementations, a rotary actuator-hinge device is presented. In some embodiments, the rotary actuator-hinge device may include a hinge device having a first member configured to attached to a first body, a second member configured to attach to a second body and to rotate relative to the first member to move the first body relative to the second body, and a selecting portion configured to selectively change modes of the hinge device.

In some embodiments, the selecting portion may be configured to selectively change modes of the hinge device between a first mode in which the first member and the second member are prevented from rotating relative to each other, a second mode in which the second member can rotate in a first direction relative to the first member and is prevented from rotating in a second direction opposite the first direction, and a third mode in which the second member can rotate in both the first direction and the second direction relative to the first member.

In some embodiments, the first member may include an annular portion and may include a plurality of first projections extending radially inward. In some embodiments, the second member may include an annular portion and includes a plurality of second projections extending radially inward and a plurality of third projections extending radially inward.

In some embodiments, the selecting portion may include a stop member, wherein in the first mode the stop member may be positioned between one of the second projections and one of the third projections and between two of the first projections to block the second member from rotating relative to the first member.

In some embodiments, in the second mode, the stop member may be positioned radially inward of the plurality of third projections such that, when the second member rotates in the first direction, the stop member may contact the first projections and move radially inward to allow the stop member to move past the first projections and, in the second direction, the stop member may be positioned between one of the first projections and one of the second projection to prevent the second member from rotating in the second direction.

In some embodiments, in the third mode, the stop member may be positioned radially inward of the second projections and the first projections to allow the second member to rotate in both the first direction and the second direction.

In some embodiments, the stop member may be biased against one of the second projections.

In some embodiments, the selecting portion may include an annular selecting member configured to rotate to move the stop member to change between the first mode, the second mode, and the third mode.

In some embodiments, the second member may be driven by a first actuator and the annular selecting member is driven by a second actuator.

In some embodiments, the first member, the second member, and the annular selecting member may be arranged coaxially.

In some embodiments, an aircraft wing assembly may include a fixed wing portion, a movable wing portion configured to pivot relative to the fixed wing portion, and a hinge device configured to connect the movable wing portion to the fixed wing portion.

In some embodiments, the hinge device may include a first member configured to attached to a fixed wing portion, a second member configured to attach to the movable wing portion and to rotate relative to the first member, and a selecting portion configured to selectively change modes of the hinge device.

In some embodiments, a selecting portion may be configured to selectively change modes of the hinge device between a first mode in which the first member and the second member are prevented from rotating relative to each other, a second mode in which the second member can rotate in a first direction relative to the first member and is prevented from rotating in a second direction opposite the first direction, and a third mode in which the second member can rotate in both the first direction and the second direction relative to the first member.

In some embodiments, the first member may include an annular portion and may include a plurality of first projections extending radially inward.

In some embodiments, the second member may include an annular portion and may include a plurality of second projections extending radially inward and a plurality of third projections extending radially inward.

In some embodiments, the selecting portion may include a stop member. In some embodiments, in the first mode, the stop member may be positioned between one of the second projections and one of the third projections and between two of the first projections to block the second member from rotating relative to the first member.

In some embodiments, in the second mode, the stop member may be positioned radially inward of the third projections, such that when the second member rotates in the first direction, the stop member may contact the first projections and may move radially inward to allow the stop member to move past the first projections and, in the second direction, the stop member may be positioned between one of the first projections and one of the second projection to prevent the second member from rotating in the second direction.

In some embodiments, in the third mode, the stop member may be positioned radially inward of the plurality of second projections and the first projections to allow the second member to rotate in both the first direction and the second direction.

In some embodiments, the selecting portion may include an annular selecting member configured to rotate to move the stop member to change between the first mode, the second mode, and the third mode.

In some embodiments, the aircraft wing assembly may include a first actuator configured rotate the second member and a second actuator configured to rotate the annular selecting member.

In some embodiments, a method for controlling movement of a movable wing portion of an aircraft relative to a fixed wing portion may include preventing pivoting of the movable wing portion relative to the fixed wing portion by selecting a first mode of the hinge device.

In some embodiments, the method may include allowing pivoting of the movable wing portion relative to the fixed wing portion in a first direction while preventing pivoting of the movable wing portion relative to the fixed wing portion in a second direction opposite the first direction by selecting a second mode of the hinge device.

In some embodiments, the method may include allowing pivoting of the movable wing portion relative to the fixed wing portion in both the first direction and the second direction by selecting a third mode of the hinge device.

In some embodiments, selecting the first mode, the second mode, and the third mode may include rotating a selecting member of the hinge device relative to a first member of the hinge device that is attached to the fixed wing portion.

In some embodiments, the method may include rotating, with a first actuator, a second member of the hinge device relative to the first member to move the movable wing portion relative to the fixed wing portion in one of the first mode or the second mode, and wherein rotating the selecting member further comprising rotating the selecting member with a second actuator.

In some embodiments, selecting a first mode of the hinge device may include positioning a stop member between a projection on the first member and a projection on the second member.

In some embodiments, selecting the third mode of the hinge device may include positioning the stop member radially inward of the projection on the first member.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1A is a perspective view of an aircraft on which an example rotary actuator-hinge mechanism according to the present application may be used.

FIG. 1B is an enlarged simplified representation of a portion of a wing of the aircraft of FIG. 1A showing use of two rotary actuator-hinge mechanisms to actuate an aileron.

FIG. 2 is an enlarged simplified representation of a folding wing tip of an aircraft showing use of the rotary actuator-hinge device to actuate the folding wing tip.

FIG. 3 is a perspective view of the example hinge device.

FIG. 4 is an exploded view of the hinge device of FIG. 3.

FIG. 5 is a front view of an example fixed member of the hinge device of FIG. 3.

FIG. 6 is a front view of an example movable member of hinge device of FIG. 3.

FIG. 7 is a front view of an example selecting member of the hinge device of FIG. 3.

FIG. 8 is a sectioned perspective view of the hinge device of FIG. 3.

FIG. 9 is a front view of the of the hinge device of FIG. 3 in a locked mode.

FIG. 10 is a front view of the of the hinge device of FIG. 3 in a unidirectional mode.

FIG. 11 is a front view of the of the hinge device of FIG. 3 in a bidirectional mode.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

These and other features and advantages are shown and described herein in reference to the figures.

Disclosed herein is a hinge-actuator device 100 configured to pivot a first body (e.g., a movable member) relative to a second body (e.g., a fixed member). In some embodiments, the hinge-actuator device 100 may be configured to transmit load with high efficiency and to disconnect input load from output smoothly even when highly loaded. In some embodiments, the hinge-actuator device 100 may provide selectable locking and direction control. For example, in some embodiments, the hinge-actuator device 100 may be configured to lock relative pivotal movement between the first body and the second body. In some embodiments, the hinge-actuator device 100 may be configured to allow the first body to pivot in a first direction relative to the second body while preventing the first body from pivoting in the opposite direction relative to the second body (i.e., unidirectional). In some embodiments, the hinge-actuator device 100 may be configured to allow the first body to pivot in a first direction relative to the second body and to pivot in a second direction opposite the first direction (i.e., bidirectional).

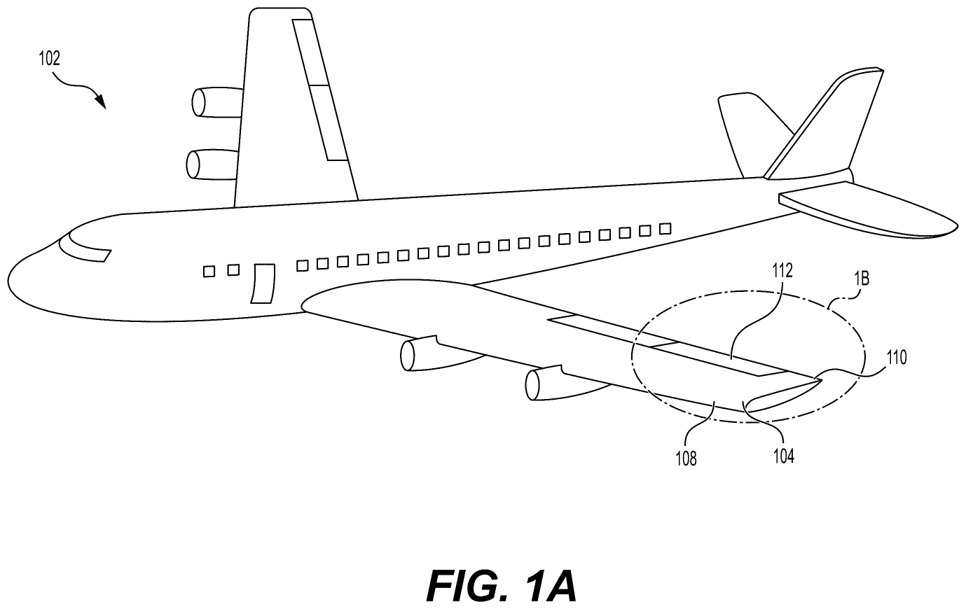

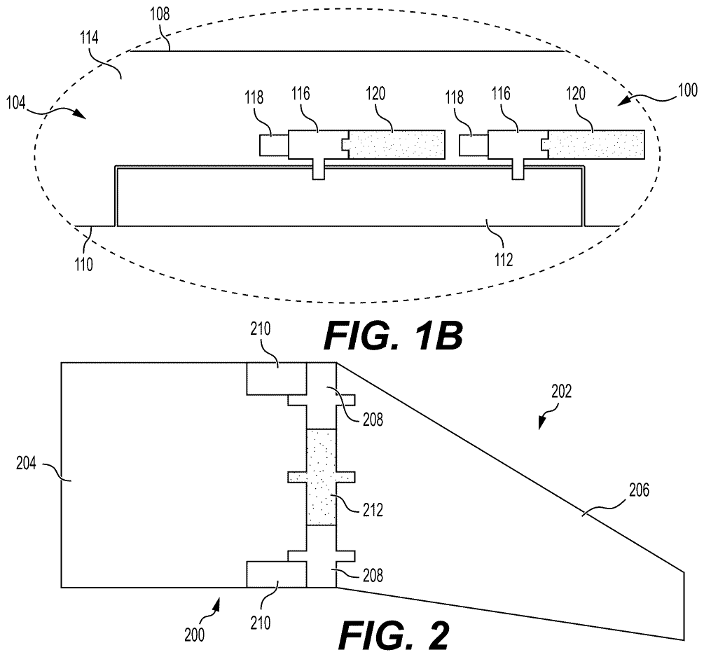

FIGS. 1A-1B illustrate an example application of the hinge-actuator device 100. In the illustrated example, an aircraft 102 includes a pair of wings 104 extending from a fuselage 106. Each wing 104 includes a leading edge 108 and a trailing edge 110. Each wing 104 includes an aileron 112 as part of the trailing edge 110 that is configured to pivot relative to a fixed portion 114 of the wing 104 for adjusting roll of the aircraft 102. As shown in FIG. 1B, each wing 104 may include one or more hinge-actuator devices 100 connecting the aileron 112 and the fixed portion 114.

In some embodiments, each of the one or more hinge-actuator devices 100 may include a hinge device 116 and an actuator 118 for selectively changing the modes of the hinge device 116. Any suitable actuator 118 (e.g., a rotary actuator) capable of changing the mode of the hinge device 116 may be used. In some embodiments, the hinge-actuator device 100 may also include, or be associated with, an actuator 120 configured to actuate one or more hinge devices 116 to move the aileron 112 relative to the fixed portion 114. Any suitable actuator 120 (e.g., a rotary actuator) capable of actuating the hinge device 116 to move the aileron 112 relative to the fixed portion 114 may be used. In some embodiments, the actuator 118 and/or the actuator 120 may be used to actuate more than one hinge device 116.

In some embodiments, two hinge-actuator devices 100 may be used to move the aileron 112. In other embodiments, more or less than two hinge-actuator devices 100 may be used. While the example application illustrates the hinge-actuator devices 100 configured to move the aileron 112 relative to the fixed portion 114 of the wing 104, the hinge-actuator devices 100 may be used in a variety of applications where a first portion is pivoted relative to a second portion.

FIG. 2 illustrates an example application of the hinge-actuator device 200 used with a folding aircraft wing 202. In the illustrated example, the wing 202 includes a fixed portion 204 and foldable tip portion 206 configured to pivot relative to a fixed portion 204 of the wing 202. Each wing 202 may include one or more hinge-actuator devices 200 connecting the foldable tip portion 206 and the fixed portion 204. In some embodiments, each of the one or more hinge-actuator devices 200 may include a hinge device 208 and an actuator 210 for selectively changing the mode of the hinge device 208. Any suitable actuator 210 (e.g., a rotary actuator) capable of changing the mode of the hinge device 208 may be used.

In some embodiments, the hinge-actuator device(s) 200 may also include, or be associated with, an actuator 212 configured to actuate one or more hinge devices 208 to move the foldable wing tip 206 relative to the fixed portion 204. Any suitable actuator 212 (e.g., a rotary actuator) capable of actuating the hinge device 208 to move the foldable wing tip 206 relative to the fixed portion 204 may be used. In some embodiments, the actuator 210 and/or the actuator 212 may be used to actuate more than one hinge device 208. In some embodiments, the actuator 210 may be used to move two hinge-actuator devices 200 to move the foldable wing tip 206. In other embodiments, more or less than two hinge-actuator devices 200 may be used.

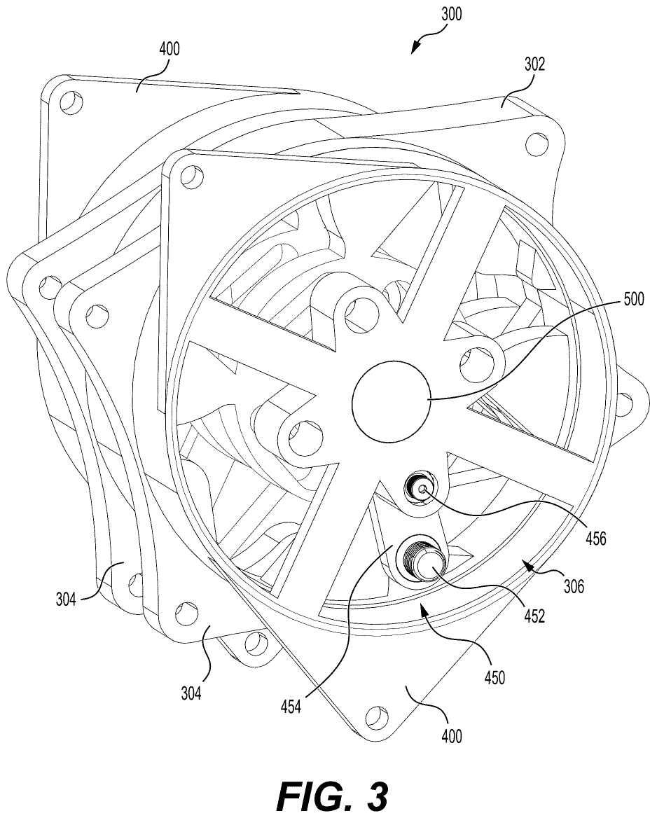

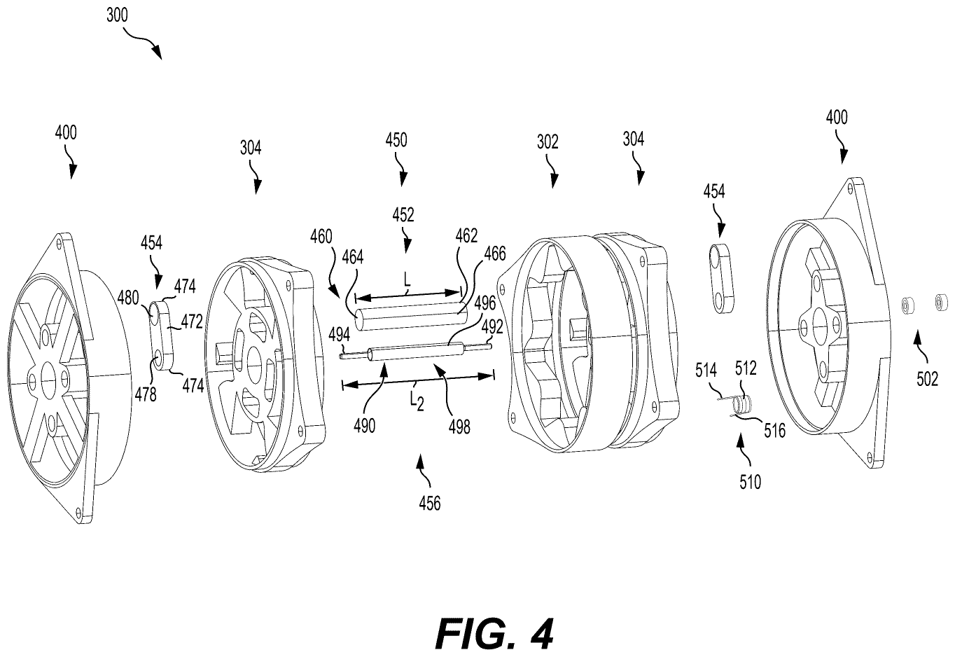

FIGS. 3-4 illustrate an example hinge device 300 according to the present application. In some embodiments, the hinge device 300 may be configured to transmit load with high efficiency, disconnect input load from output smoothly even when highly loaded, and provide selectable locking and direction control. The hinge device 300 may be configured in a variety of ways.

In some embodiments, the hinge device 300 may include one or more first members 302 (e.g., a fixed member) configured to attach to a first body (e.g., the fixed portion 114, 204 of a wing), one or more second members 304 (e.g., a movable member) configured to attach to a second body (e.g., a movable portion such as the aileron 112 or foldable tip portion 206) and a selecting portion 306 configured to selectively change modes of the hinge device 300. In some embodiments, the one or more first members 302 may be fixed to a fixed portion 114, 204 and the one or more second members 304 may be fixed to a movable portion (e.g., the aileron 112 or foldable tip portion 206) configured to move relative to the fixed portion. In other embodiments, however, the one or more first members 302 and the one or more second members 304 may attach to any two bodies that the hinge device 300 can move relative to each other.

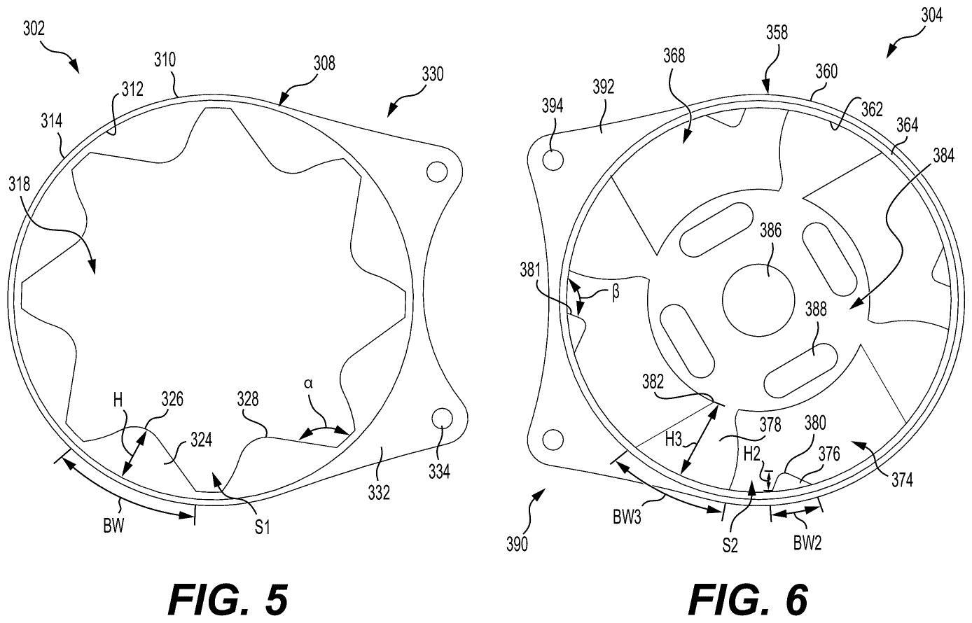

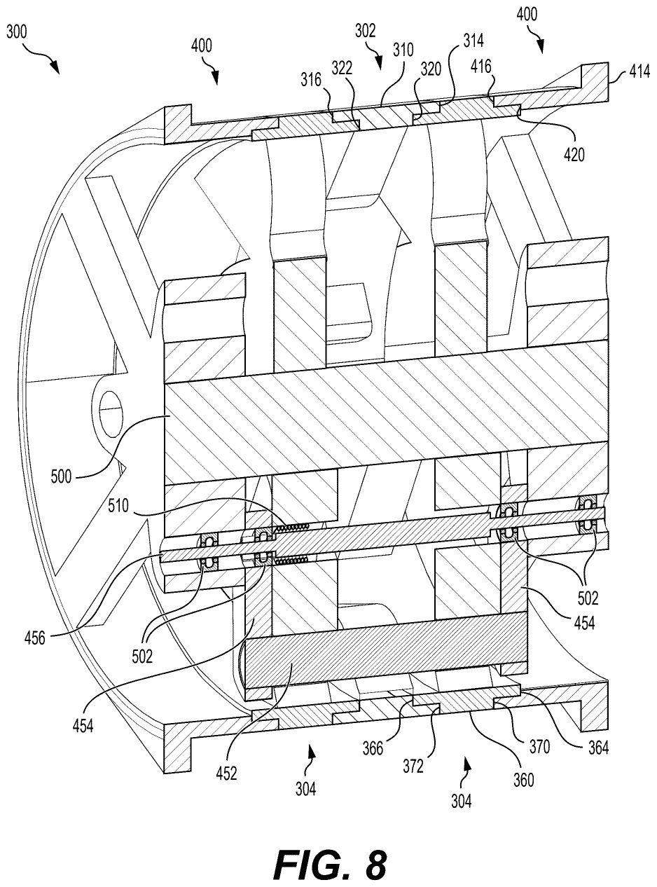

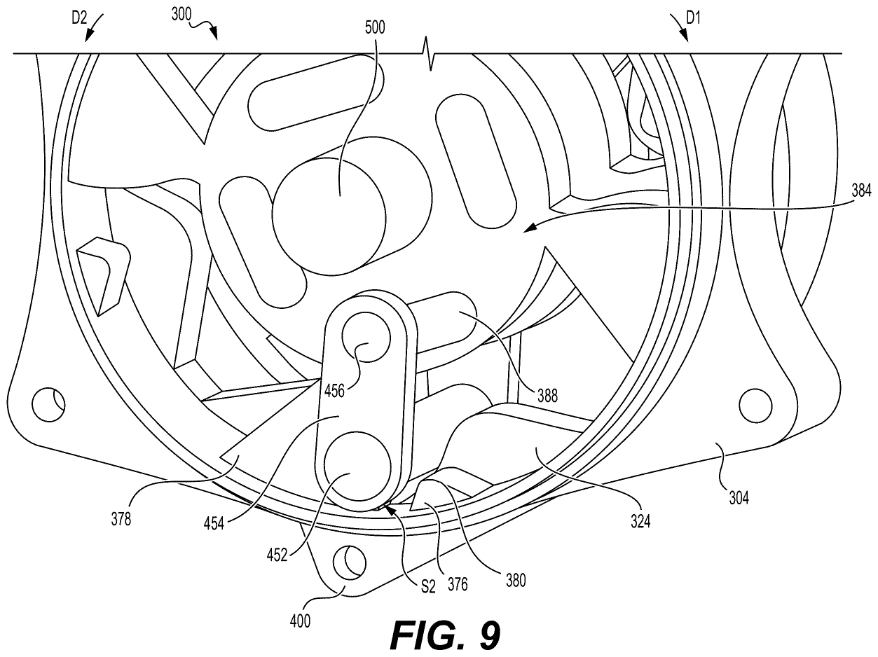

FIG. 5 illustrates an example first member or fixed member 302. The first member 302 may be configured in a variety of ways. In some embodiments, the first member 302 may include an annular sidewall 308 having an outer side surface 310, an inner side surface 312 opposite the outer side surface 310. The sidewall 308 may include a forward side or edge 314 and a rearward side or edge 316 (FIG. 8) and define an opening 318 extending through the first member 302 from the forward side 314 to the rearward side 316.

In some embodiments, the first member 302 may be configured to engage the one or more second members 304. For example, in some embodiments, the one or more second members 304 may nest with the first member 302 or vice versa. In some embodiments, the inner side surface 312 may include one or more radial shoulders, such as for example a first radial shoulder 320 and an opposing second radial should 322.

In some embodiments, the inner side surface 312 may include one or more first projections 324 extending radially inward. In some embodiments, the one or more first projections 324 may include a series of projections extending around a circumference of the inner side surface 312 with adjacent first projections 324 separated by a space S1. For example, in some embodiments, the one or more first projections 324 may include eight first projections 324 evenly spaced apart around the circumference of the inner side surface 312.

Each of the first projections 324 may be configured in a variety of ways (e.g., a fixed structure, a roller, etc.). In some embodiments, each first projection 324 may be a triangular shape with a rounded apex 326, a base width BW, and a height H. In some embodiments, the base width may be larger than the height H. In some embodiments, the projection 324 may have an engaging surface 328 configured to contact and engage the selecting portion 306. In some embodiments, the engaging surface 328 extends radially inward at an angle α. In some embodiments, the angle α may be configured to allow smooth transition between modes of the hinge device 300 (e.g., without requiring high torque to unlock and change modes). In some embodiments, the angle α may be in the range of 115-145 degrees, or 120-140 degrees, or 130 degrees.

In some embodiments, the first member 302 may include an attachment portion 330 configured to attach the first member 302 to the first body. The attachment portion 330 may be configured in a variety of ways. In some embodiments, the attachment portion 330 may include one or flanges 332 extending from the outer side surface 310 (e.g., extending radially) having one or more fastener receiving openings 334 for receiving fasteners (not shown)(e.g., bolts, pins, etc.).

FIG. 6 illustrates an example second member 304. The second member 304 may be configured in a variety of ways. In some embodiments, the second member 304 may include an annular sidewall 358 having an outer side surface 360, an inner side surface 362 opposite the outer side surface 360. The sidewall 358 may include a forward side or edge 364 and a rearward side or edge 366 (FIG. 8) and define one or more openings 368 extending through the second member 304 from the forward side 364 to the rearward side 366.

In some embodiments, the second member 304 may be configured to engage one or more additional members (e.g., the first member 302). For example, in some embodiments, the second member 304 may nest with the first member 302 or vice versa. In some embodiments, the outer side surface 360 may include one or more radial shoulders, such as for example a first radial shoulder 370 and an opposing second radial should 372.

In some embodiments, the inner side surface 362 may include one or more projections 374 extending radially inward. In some embodiments, the one or more projections 374 may include one or more second projections 376 and one or more third projections 378. In some embodiments, the one or more projections 374 may include a series of spaced-apart second projections 376 extending around a circumference of the inner side surface 362. In some embodiments, the one or more projections 374 may include a series of spaced-apart third projections 378 extending around a circumference of the inner side surface 362. For example, in some embodiments, the one or more second projections 376 may include four second projections 376 evenly spaced apart around the circumference of the inner side surface 362. In some embodiments, the one or more third projections 378 may include four third projections 378 evenly spaced apart around the circumference of the inner side surface 362. In some embodiments, the one or more projections 374 may be arranged in pairs of one second projection 376 and one third projection 378 separated by a space S2.

Each of the second projections 376 may be configured in a variety of ways. In some embodiments, each second projection 376 may be a triangular shape with a rounded apex 380, a base width BW2, and a height H2. In some embodiments, the base width BW2 may be larger than the height H2. In some embodiments, the projection 376 may have an engaging surface 381 configured to contact and engage the selecting portion 306. In some embodiments, the engaging surface 381 extends radially inward at an angle β. In some embodiments, the angle α may be in the range of 95-115 degrees, or 100-110 degrees, or 105 degrees.

Each of the third projections 378 may be configured in a variety of ways. In some embodiments, each third projection 378 may be a triangular shape with an apex 382, a base width BW3, and a height H3. In some embodiments, the base width BW3 may be larger than the height H3.

In some embodiments, the apex 382 of each of the third projections 378 may be connected (e.g., integral with) a central portion 384. The central portion 384 may be configured in a variety of ways. In some embodiments, the central portion 384 may be disc-shaped. In some embodiments, the central portion 384 may include a central aperture 386 configured to receive a shaft of a rotary actuator configured to rotate the second member 304. In some embodiments, the central portion 384 may include one or more openings or slots 388 extending circumferentially. In some embodiments, the one or more slots 388 may include four spaced-apart slots 388 evenly spaced around the central aperture 386. In some embodiments, each of the four spaced-apart slots 388 may be positioned circumferentially between two of the third projections 378.

In some embodiments, the second member 304 may include an attachment portion 390 configured to attach the second member 304 to the second body. The attachment portion 390 may be configured in a variety of ways. In some embodiments, the attachment portion 390 may include one or more flanges 392 extending from the outer side surface 360 (e.g., extending radially) having one or more fastener receiving openings 394 for receiving fasteners (not shown)(e.g., bolts, pins, etc.).

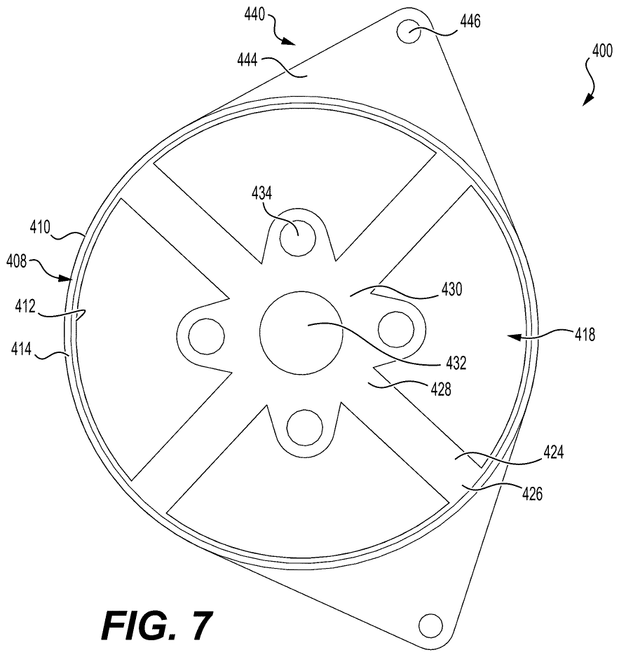

FIG. 7 illustrates an example third member or selecting member 400 of the selecting portion 306. The selecting member 400 may be configured in a variety of ways. In some embodiments, the selecting member 400 may include an annular sidewall 408 having an outer side surface 410, an inner side surface 412 opposite the outer side surface 410. The sidewall 408 may include a forward side or edge 414 and a rearward side or edge 416 and may define one or more passages 418 extending through the selecting member 400 from the forward side 414 to the rearward side 416.

In some embodiments, the selecting member 400 may be configured to engage one or more additional members (e.g., the second member 304). For example, in some embodiments, the selecting member 400 may nest with the second member 304 or vice versa. In some embodiments, the inner side surface 412 may include one or more radial shoulders, such as for example a first radial shoulder 420.

In some embodiments, the inner side surface 412 may include one or more projections 424 extending radially inward. In some embodiments, the one or more projections 424. In some embodiments, the one or more projections 424 may include a series of spaced-apart projections 424 extending around a circumference of the inner side surface 412. For example, in some embodiments, the one or more projections 424 may include four projections 424 evenly spaced apart around the circumference of the inner side surface 412.

Each of the projections 424 may be configured in a variety of ways. In some embodiments, the projections 424 may extend radially to connect the inner side surface 412 to a central portion 430. For example, each projection 424 may have a rectangular shape with a proximal end 426 attached to the inner side surface 412 and a distal end 428 attached to a central portion 430. The central portion 430 may be configured in a variety of ways. In some embodiments, the central portion 430 may include a central aperture 432 configured to receive a shaft of a rotary actuator. In some embodiments, the central portion 430 may include one or more openings 434 radially offset from the central aperture 432. In some embodiments, the central portion 430 may include four spaced-apart openings 434 evenly spaced around the central aperture 432. In some embodiments, each of the four spaced-apart openings 434 may be positioned circumferentially between two of the projections 424.

In some embodiments, the selecting member 400 may include an attachment portion 440 configured to attach the selecting member 400 to a rotary actuator 118, 210 configured to rotate the selecting member 400 relative to the second member 304. The attachment portion 440 may be configured in a variety of ways. In some embodiments, the attachment portion 440 may include one or more flanges 444 extending from the outer side surface 410 (e.g., extending radially) having one or more fastener receiving openings 446 for receiving fasteners (not shown)(e.g., bolts, pins, etc.).

Referring to FIGS. 3, 4 and 8, in some embodiments, the hinge device 300 may include one or more first members 302, one or more second members 304, and one or more selecting members 400 arranged coaxially side-by-side. In some embodiments, the hinge device 300 may include one first member 302 positioned between two second members 304, one on either side of the first member 302. In some embodiments, each of the second members 304 may partially nest with the first member 302 or vice versa. For example, as shown in FIG. 8, in some embodiments, the forward side 314 of the first member 302 may overlap the rearward side 366 of a forward one of the second members 304 such that the forward side 314 abuts the second radial shoulder 372 of the second member 304 and the rearward side 366 abuts the first radial shoulder 320 of the first member 302. Similarly, the rearward side 316 of the first member 302 may overlap the forward side 364 of a rearward one of the second members 304 such that the rearward side 316 abuts the first radial shoulder 370 of the second member 304 and the forward side 364 abuts the second radial shoulder 322 of the first member 302.

Similarly, the selecting members 400 may partially nest with corresponding second member 304 or vice versa. For example, as shown in FIG. 8, the forward side 364 of the second member 304 may overlap the rearward side 416 of the selecting member 400 such that the forward side 364 abut the first radial shoulder 420 of the selecting member 400 and the rearward side 416 abut the first radial shoulder 370 of the second member 304.

In some embodiments, the selecting portion 306 may include an engaging portion 450 configured to be moved by the selecting member 400 to change modes of the hinge device 300. For example, in some embodiments, hinge device 300 may have a locked mode in which the first member 302 and the second member 304 are prevented from rotating relative to each other, a unidirectional mode in which the second member 304 can rotate in a first direction relative to the first member 302 but is prevented from rotating in a second direction opposite the first direction, and a bidirectional mode in which the second member 304 can rotate in both the first direction and the second direction relative to the first member 302.

In some embodiments, the engaging portion 450 may include one or more first members or stop members 452 coupled to one or more links 454 that are pivotably connected to the selecting member 400 by one or more second members or pivot members 456. The stop members 452 may be configured to engage one or more of the first projections 324 on the first member 302 and one or more of the second and third projections 376, 378 on the second members 304 to selectively block rotation of the second members 304 relative to the first member 302. The one or more stop members 452 may be configured in a variety of ways.

In some embodiments, the one or more stop members 452 may include an elongated body 460 (e.g., a rod, a pin, a beam, etc.) having a proximal end 462 and a distal end 464 opposite the proximal end 462. In some embodiments, the elongated body 460 may have a cylindrical sidewall 466 and a length L.

The one or more links 454 may be configured to couple the one or more stop members 452 to the selecting member 400. The one or more links 454 may be configured in a variety of ways. In some embodiments, the one or more links 454 may include an elongated body 472 having a proximal end 474 and a distal end 476 opposite the proximal end 474. In some embodiments, the proximal end 474 may have be configured to couple with the second or pivot member 456. For example, the proximal end 474 may include a first opening 478 through which the pivot member 456 may be received. In some embodiments, the distal end 476 may be configured to couple to the stop member 452. For example, the distal end 476 may include a second opening 480 through which the first or stop member 452 may be received.

The second or pivot member 456 may be configured to pivotably couple the one or more links 454 to the one or more selecting members 400. The second or pivot member 456 may be configured in a variety of ways. In some embodiments, the one or more pivot members 456 may include an elongated body 490 (e.g., a rod, a pin, a beam, etc.) having a proximal end 492 and a distal end 494 opposite the proximal end 492. In some embodiments, the elongated body 490 may have a cylindrical sidewall 496 and a length L2. In some embodiments, the elongated body 490 has a larger diameter intermediate portion 498 between the proximal end 492 and the distal end 494.

Referring to FIG. 8, in some embodiments, when assembled, the first member 302, the second members 304, and the selecting members 400 may be arranged coaxially side-by-side with a link 454 positioned between the second and selecting members 304, 400. The central aperture 386 of each of the second members 304 and the central aperture 432 of each of the selecting members 400 may be aligned and configured to receive an output shaft 500 of a rotary actuator (not shown)(e.g., actuator 120, 212). The output shaft 500 may be rotationally fixed with the second members 304 such that rotation of the output shaft 500 rotates the second members 304 relative to the first member 302. The output shaft 500 may be rotationally fixed to the second members 304 by any suitable means (e.g., splined connection, fasteners, etc.).

In some embodiments, the elongated body 490 and length L2 of the pivot member 456 may be configured such that the pivot member 456 is received through one of the openings 434 in one of the selecting members 400, extends through the first opening 478 in one of the links 454, extends through one of the slots 388 in one of the second members 304, extends through the opening 318 in the first member 302, extends through one of the slots 388 in the other second member 304, extends through the first opening 478 in the other link 454, extends through one of the opening 434 in the other selecting member 400, and is secured in place. In some embodiments, the pivot member 456 may be supported within the openings 434, 478 by one or more bearing assemblies 502 (e.g., roller bearings)

In some embodiments, the elongated body 460 and length L of the stop member 452 may be configured such that the stop member 452 is received through one the second opening 480 in one of the links 454, extends through the opening 368 in one of the second members 304, extends through the opening 318 in the first member 302, extends through the opening 368 in the other second member 304, extends through the second opening 480 in the other link 454, and is secured in place. In some embodiments, the stop member 452 may be supported within the openings 480 by one or more bearing assemblies (e.g., roller bearings)(not shown).

In some embodiments, the engaging portion 450 may be configured to bias the stop member 452 against one of the third projections 378. The engaging portion 450 may be configured to bias the stop member 452 against one of the third projections 378 in any suitable manner. For example, in some embodiments, the engaging portion 450 may include one or more biasing members 510 (e.g., a torsion spring(s)) positioned to bias the engaging portion 450 such that the stop member 452 is biased against one of the third projections 378. In some embodiments, the biasing member 510 may be one or more torsion springs having a coil portion 512, a first leg 514, and a second leg 516 opposite the first leg 514. In some embodiments, the pivot member 456 may be received through the coil portion 512 of one or more biasing members 510 with the first leg 514 biased against the stop member 452 and the second leg biased against the received around the pivot member 456.

In the illustrated embodiments, the engaging portion 450 is shown to include a stop member 452, a pivot member 456, and two links 454 arranged in a quadrant of the hinge device 300. Thus, one of the four openings 434 in the selecting members 400 and one of the four slots 388 receives the pivot member 456 and the pivot member 456 supports the stop member 452 via two links 454. In other embodiments, however, the additional groups of the engaging portion 450 may include additional groupings of a stop member 452, a pivot member 456, and links 454. For example, one or more of three other quadrants of the hinge device 300 may include a stop member 452, a pivot member 456, and links 454. In some embodiments, a stop member 452, a pivot member 456, and links 454 may be in each of the four quadrants (i.e., patterned circumferentially around the hinge device 300) such that each of the four openings 434 and four slot 488 receive a corresponding pivot member 456 that supports corresponding stop member 452 and links 454. The engaging portion 450 configured with multiple arrangements of a stop member 452, a pivot member 456, and links 454 increases the load capabilities of the hinge device 300.

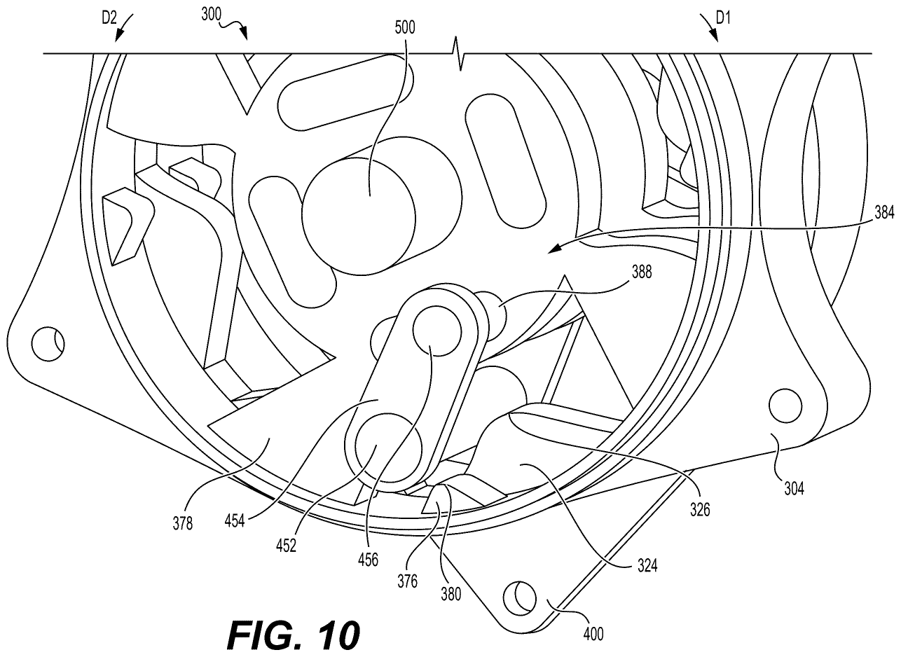

FIGS. 9-11 illustrate the hinge device 300 in various modes. In FIG. 9, the hinge device 300 is illustrated in the locked mode. In the locked mode, the stop member 452 is positioned in the space S1 between two first projections 324 on the first member 302 and in the space S2 between one second projection 376 and one third projection 378 on each of the second members 304. Thus, the second members 304 are prevented from rotating in a first direction, as shown by arrow D1 in FIG. 9, because the stop member 452 is positioned between a first projection 324 and a third projection 378 and are prevented from rotating in a second direction, as shown by arrow D2, because the stop member 452 is positioned between a first projection 324 and a second projection 376.

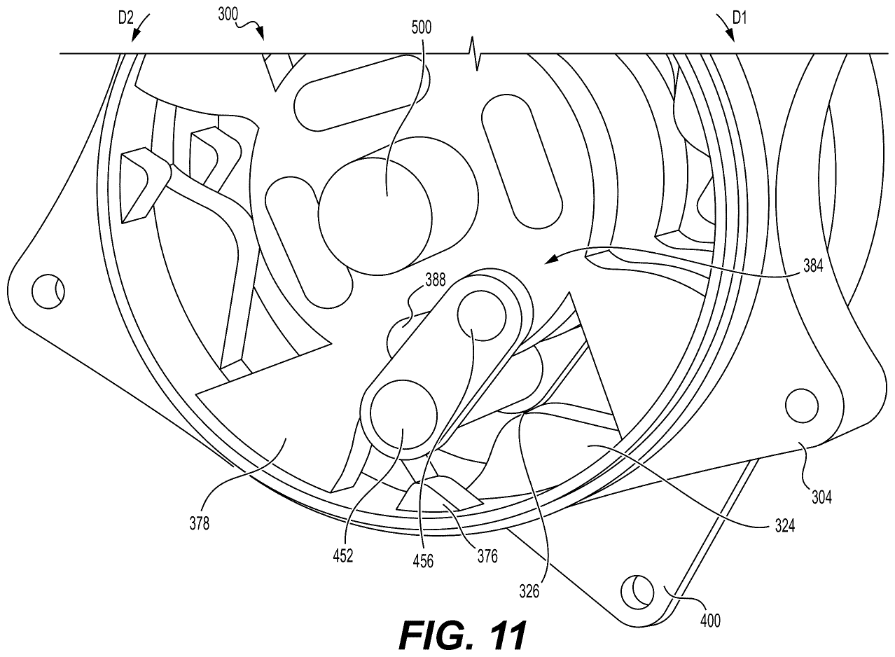

In FIG. 10, the hinge device 300 is illustrated in a unidirectional mode. In the unidirectional mode, the stop member 452 is positioned radially inward from the position of the stop member 452 in the locked mode such that the stop member 452 is radially inward of the apex 380 of the second projections 376 on the second members 304 but not radially inward of the apex 326 of the first projections 324 of the first member 302. The stop member 452 may be moved by rotating the selecting members 400 relative to the second members 304. For example, in reference to the orientations of FIGS. 9-11, by rotating the selecting members 400 counterclockwise moves the pivot member 456 along the slot 388 in the second members 304 in a left to right direction; thus, moving the stop member 452 radially inward.

With the stop member 452 radially inward of the apex 380 but not radially inward of the apex 326, the second members 304 are prevented from rotating in the first direction, as shown by arrow D1 in FIG. 10, because the stop member 452 is positioned between a first projection 324 and a third projection 378, but allowed to rotate in the second direction, as shown by arrow D2 in FIG. 10. When rotating in the second direction, the first projections 324 may contact and move the stop member 452 (i.e. pivot the engaging portion 450 about the pivot member 456) out of the path of the first projection 324 since the second projection 376 is not longer blocking movement of the stop member 452 in that direction. Once the first projection 324 move past the stop member 452, the biasing member 510 biased the stop member 452 back toward the third projection 378.

In FIG. 11, the hinge device 300 is illustrated in a bidirectional mode. In the bidirectional mode, the stop member 452 is positioned radially inward both the apex 380 of the second projections 376 on the second members 304 and radially inward of the apex 326 of the first projections 324 of the first member 302. The stop member 452 may be moved by further rotating the selecting members 400 counterclockwise moves the pivot member 456 along the slot 388 in the second members 304 in a left to right direction.

With the stop member 452 radially inward of the apex 380 and the apex 326, the second members 304 may rotate relative to the first member 302 in both the first direction, shown by arrow D1 in FIG. 11, and the second direction, as shown by arrow D2 in FIG. 10 since the stop member 452 does not contact the first projections 324.

The disclosed hinge-actuator assembly may be configured to transmit load with high efficiency, disconnect input load from output smoothly even when highly loaded and/or provide selectable locking and direction control. In applications in which the hinge device is used with a fixed wing portion and a folding wing portion, in some embodiments, the hinge device may be configured to release.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. Although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A hinge device, comprising:
a first member configured to attached to a first body;
a second member configured to attach to a second body and to rotate relative to the first member to move the first body relative to the second body; and
a selecting portion configured to selectively change modes of the hinge device between a first mode in which the first member and the second member are prevented from rotating relative to each other, a second mode in which the second member can rotate in a first direction relative to the first member and is prevented from rotating in a second direction opposite the first direction, and a third mode in which the second member can rotate in both the first direction and the second direction relative to the first member.

2. The hinge device of claim 1, wherein the first member includes an annular portion and includes a plurality of first projections extending radially inward and the second member includes an annular portion and includes a plurality of second projections extending radially inward and a plurality of third projections extending radially inward.

3. The hinge device of claim 2, wherein the selecting portion includes a stop member, wherein in the first mode the stop member is positioned between one of the second projections and one of the third projections and between two of the first projections to block the second member from rotating relative to the first member.

4. The hinge device of claim 3, wherein in the second mode, the stop member is positioned radially inward of the plurality of third projections such that, when the second member rotates in the first direction, the stop member contacts the first projections and moves radially inward to allow the stop member to move past the first projections and, in the second direction, the stop member is positioned between one of the first projections and one of the second projection to prevent the second member from rotating in the second direction.

5. The hinge device of claim 4, wherein in the third mode, the stop member is positioned radially inward of the second projections and the first projections to allow the second member to rotate in both the first direction and the second direction.

6. The hinge device of claim 3, wherein the stop member is biased against one of the second projections.

7. The hinge device of claim 3, wherein the selecting portion includes an annular selecting member configured to rotate to move the stop member to change between the first mode, the second mode, and the third mode.

8. The hinge device of claim 7, wherein the second member is driven by a first actuator and the annular selecting member is driven by a second actuator.

9. The hinge device of claim 7, wherein the first member, the second member, and the annular selecting member are arranged coaxially.

10. An aircraft wing assembly, comprising
a fixed wing portion;
a movable wing portion configured to pivot relative to the fixed wing portion;
a hinge device configured to connect the movable wing portion to the fixed wing portion;
wherein the hinge device comprises:
a first member configured to attached to a fixed wing portion;
a second member configured to attach to the movable wing portion and to rotate relative to the first member; and
a selecting portion configured to selectively change modes of the hinge device between a first mode in which the first member and the second member are prevented from rotating relative to each other, a second mode in which the second member can rotate in a first direction relative to the first member and is prevented from rotating in a second direction opposite the first direction, and a third mode in which the second member can rotate in both the first direction and the second direction relative to the first member.

11. The aircraft wing assembly of claim 10, wherein the first member includes an annular portion and includes a plurality of first projections extending radially inward and the second member includes an annular portion and includes a plurality of second projections extending radially inward and a plurality of third projections extending radially inward.

12. The aircraft wing assembly of claim 11, wherein the selecting portion includes a stop member, wherein in the first mode the stop member is positioned between one of the second projections and one of the third projections and between two of the first projections to block the second member from rotating relative to the first member.

13. The aircraft wing assembly of claim 12, wherein in the second mode, the stop member is positioned radially inward of the third projections, such that when the second member rotates in the first direction, the stop member contacts the first projections and moves radially inward to allow the stop member to move past the first projections and, in the second direction, the stop member is positioned between one of the first projections and one of the second projection to prevent the second member from rotating in the second direction.

14. The aircraft wing assembly of claim 13, wherein in the third mode, the stop member is positioned radially inward of the plurality of second projections and the first projections to allow the second member to rotate in both the first direction and the second direction.

15. The aircraft wing assembly of claim 12, wherein the selecting portion includes an annular selecting member configured to rotate to move the stop member to change between the first mode, the second mode, and the third mode.

16. The aircraft wing assembly of claim 15, further comprising a first actuator configured rotate the second member and a second actuator configured to rotate the annular selecting member.

17. A method for controlling movement of a movable wing portion of an aircraft relative to a fixed wing portion, wherein the movable wing portion is connected to the fixed wing portion by a hinge device, comprising:
preventing pivoting of the movable wing portion relative to the fixed wing portion by selecting a first mode of the hinge device;
allowing pivoting of the movable wing portion relative to the fixed wing portion in a first direction while preventing pivoting of the movable wing portion relative to the fixed wing portion in a second direction opposite the first direction by selecting a second mode of the hinge device;
allowing pivoting of the movable wing portion relative to the fixed wing portion in both the first direction and the second direction by selecting a third mode of the hinge device; and
wherein selecting the first mode, the second mode, and the third mode comprises rotating a selecting member of the hinge device relative to a first member of the hinge device that is attached to the fixed wing portion.

18. The method of claim 17, further comprising rotating, with a first actuator, a second member of the hinge device relative to the first member to move the movable wing portion relative to the fixed wing portion in one of the first mode or the second mode, and wherein rotating the selecting member further comprising rotating the selecting member with a second actuator.

19. The method of claim 18, wherein selecting a first mode of the hinge device further comprises positioning a stop member between a projection on the first member and a projection on the second member.

20. The method of claim 19, wherein selecting the third mode of the hinge device further comprising positioning the stop member radially inward of the projection on the first member.
